(19) United States
(12) Patent Application Publication
(10) Pub. No.: US 2025/0187109 A1
(43) Pub. Date: Jun. 12, 2025

(54) METHOD AND DEVICE FOR FORMING A STRUCTURE ON A WORKPIECE

(71) Applicant: Fraunhofer-Gesellschaft zur Förderung der angewandten Forschung e.V., München (DE)

(72) Inventors: Georg HOPPE, Freiburg (DE); Fabian MEYER, Freiburg (DE); Jale SCHNEIDER, Freiburg (DE); Andreas BRAND, Freiburg (DE); Simon Holger GUTSCHER, Freiburg (DE); Jan NEKARDA, Freiburg (DE)

(73) Assignee: Fraunhofer-Gesellschaft zur Förderung der angewandten Forschung e.V., München (DE)

(21) Appl. No.: 18/856,152

(22) PCT Filed: Mar. 31, 2023
(86) PCT No.: PCT/EP2023/058496

§ 371 Date: Oct. 11, 2024

(30) Foreign Application Priority Data
Apr. 13, 2022 (DE) 10 2022 109 021.3

(51) Int. Cl. B23K 26/03; B23K 26/042; B23K 26/046

(52) U.S. Cl. CPC B23K 26/0344; B23K 26/042; B23K 26/046

(57) ABSTRACT

A device and a method for forming a structure on a workpiece by processing radiation while the workpiece is moved by a transport device, in which correction data of the workpiece are acquired by optical sensors. The correction data includes movement data of the workpiece and/or position data of a structure created on the workpiece by the processing radiation, and, dependent on the correction data, the deflection of processing radiation brought about by a deflection unit is determined, in particular corrected.

### CROSS-REFERENCE TO RELATED APPLICATIONS

This application is a 371 National Phase of PCT/EP2023/058496, filed Mar. 31, 2023, which claims priority from German Patent Application No. 10 2022 109 021.3, filed Apr. 13, 2022, both of which are incorporated herein by reference as if fully set forth.

### BACKGROUND

The formation of a structure on a workpiece by means of electromagnetic processing radiations is known within the scope of workpiece processing. In this context, the formation of a structure might comprise a modification of the workpiece by means of processing radiation and/or a removal of material, in particular ablation, by means of processing radiation.

Laser radiation is typically used as processing radiation. Such forming of a structure and a workpiece by means of laser radiation finds use in the production of photovoltaic solar cells and in circuit board production in particular.

In order to obtain a high throughput in production, it is known practice to process the workpiece by means of processing radiation while the workpiece is moved by means of the transport device. In-line processing, in particular, can be realized thereby.

Transporting the workpiece by means of a transport device while the workpiece is being processed harbors the disadvantage that fluctuations in the transport speed and/or movements of the workpiece on the transport device, in particular rotations of the workpiece, lead to inaccuracies during the processing.

It is therefore known practice to detect a leading edge of the workpiece by means of an optical sensor prior to the processing by means of processing radiation. Such a device is described in EP 2940740 A1.

### SUMMARY

The problem addressed by the present invention is that of providing a method and a device for forming a structure on a workpiece by means of processing radiation, which enable greater precision in the event of an unsteady transport of the workpiece on the transport device.

This problem is solved by a method for forming a structure on a workpiece by means of processing radiation, according to one or more of the features disclosed herein, and by a device for forming a structure on a workpiece by means of processing radiation, having one or more of the features disclosed herein. Advantageous configurations of the method according to the invention are found in the description and claims that follow, and advantageous configurations of the device according to the invention are also found in the description and claims that follow.

Preferably, the method according to the invention is designed to be carried out by means of the device according to the invention, especially by means of a preferred embodiment thereof. Preferably, the device according to the invention is designed to carry out the method according to the invention, especially a preferred embodiment thereof.

The present invention is based on the insight that it is essential to acquire correction data of a workpiece by means of at least one optical sensor while the workpiece is processed, in order to avoid spatial deviations when the workpiece is processed by means of processing radiation.

The method according to the invention for forming a structure on a workpiece by means of processing radiation includes the following processing steps:

The workpiece is provided on a transport device in a method step A. In a method step B, the workpiece is moved along a trajectory by means of the transport device, and the workpiece is processed by means of processing radiation while the workpiece is moved by means of the transport device. In order to form the structure, the time of processing is controlled by means of a control device and, preferably, the location of processing the workpiece by means of processing radiation is controlled by means of a control device-controlled optical deflection unit for processing radiation.

Hence, the method according to the invention includes, in a manner known per se, processing during transport by means of the transport device, and so a high throughput and in-line processing are rendered possible. A control device is used to control the time of processing, in order to attain processing at the desired location of processing on the surface of the workpiece. It is advantageous to additionally control an optical deflection unit for processing radiation by means of the control device such that the optical deflection unit can be used to deflect processing radiation to different locations on the workpiece, and/or processing radiation can be deflected in such a way that the radiation is directed at a location of processing during a predetermined time interval and hence moves at the transport speed of the workpiece in the reference system of the device.

It is essential that, in method step B, while the workpiece is processed by means of processing radiation, correction data of the workpiece are acquired by means of at least one optical sensor. The correction data comprise movement data of the workpiece and/or position data of a structure created on the workpiece by means of processing radiation. Dependent on the correction data, the time of processing and/or the deflection of processing radiation brought about by means of the deflection unit is determined, in particular corrected, by means of the control device.

Workpiece transport by means of the transport device harbors various sources of error, which lead to inaccuracies and, in particular, spatial deviations when processing the work-piece by means of processing radiation: Even modern transport devices exhibit fluctuations in transport speed, and so estimates of the workpiece trajectory, which are based on a typically constant transport speed, might be erroneous. Even systems which measure the transport speed on the transport means, for example on a conveyor belt of the transport device, contain faults since there might be slip between the measuring system and the transport belt or else a change in length of the transport belt. Moreover, the workpiece might change its pose on the transport device and relative to the transport means, for example relative to a conveyor belt, in particular due to tremors and vibrations.

The method according to the invention allows a correction of such deviations since the correction data of the workpiece itself are acquired during the workpiece processing.

The scope of the invention includes the correction data containing movement data of the workpiece. The change in pose of the workpiece, and hence the position during the processing, is ascertained from the movement data. Movement data can be captured precisely and nevertheless cost-effectively by means of optical sensors, as explained in more detail below.

The scope of the invention also includes the correction data containing position data of a structure created on the workpiece by means of processing radiation. This gives rise to the advantage that structure positions, in particular distances between portions of a structure or distances between two separate structures formed by means of processing radiation, can be compared to default values, and corresponding corrections for the deflection of processing radiation brought about by means of the optical deflection unit can be calculated in order to avoid deviations during the further processing.

The scope of the invention likewise includes an acquisition of movement data of the workpiece and position data of a structure created on the workpiece by means of processing radiation, and the use thereof for the deflection of processing radiation brought about by means of the deflection unit.

In an advantageous configuration of the method according to the invention, the time of processing is additionally determined, in particular corrected, dependent on the correction data.

In an advantageous configuration of the method according to the invention, method step B includes a method step B.1, wherein a location of the workpiece is recognized before the workpiece is processed by means of processing radiation, and movement data of the workpiece are acquired in a method step B.2 after method step B.1.

As a result, the pose of the workpiece is initially captured in method step B.1. A precise calculation of the workpiece trajectory is rendered possible by acquiring the movement data in method step B.2.

In particular, it is advantageous that the acquisition of movement data in accordance with method step B.2 is started no later than the implementation of method step B.1 and is continued at least until the structure is being created by means of processing radiation, preferably until the creation of the structure by means of processing radiation is completed.

This ensures complete acquisition of the movement data, from the moment the pose is recognized until the time of processing, in particular until the completion of the processing, and so all changes in the pose of the workpiece on account of external influences are captured from the moment the pose is captured.

Advantageously, in method step B.2, the movement data of the workpiece are acquired by means of a plurality of optical detectors, in particular by means of a plurality of separate optical detectors, preferably by means of detectors arranged in an array.

The use of a plurality of optical detectors for capturing movement harbors the advantage that capture is possible over a relatively long path length, and a rotation of the workpiece, in particular about an axis perpendicular to the transport direction, is detected by way of a comparison of the movement data. For a precise capture of the movement of the workpiece, it is advantageous to arrange the optical detectors in an array, particularly preferably in a grid arrangement, wherein the detectors are arranged at the grid intersection points in a grid with rectangular, preferably square cells.

Preferably, the array comprises at least 2, in particular at least 3, preferably at least 30 detectors, in particular 32 detectors. Preferably, the array comprises rows aligned transversely to the transport direction, wherein at least 2, preferably 4, preferably at least 3 sensors are preferably arranged in each row. Preferably, the array comprises at least 2, preferably at least 4, in particular at least 8 rows.

In an advantageous development, the array comprises at least one detector for recognizing pose, preferably a plurality of detectors for recognizing pose, in addition to the detectors for capturing movement.

Advantageously, in method steps B.1 and B.2, the characteristic data are acquired by means of different optical detectors, in particular by means of detectors arranged in separate housings. As a result, the detectors can be arranged in a manner spaced apart from one another in space.

In an advantageous embodiment, the array of detectors comprises a plurality of data processing units. In particular, it is advantageous that each detector of the array has a separate data processing unit for processing the raw signals measured by the detector, particularly preferably for outputting digital measurement signals, preferably velocity signals, which reflect the measured velocity of the workpiece in at least one dimension, and preferably in two dimensions. Preferably, each detector therefore comprises a processor unit, in particular a signal processing processor (DSP), preferably having at least one microprocessor and preferably having a program and data memory.

This gives rise to the advantage that a particularly fast calculation of movement data of the workpiece is rendered possible by the decentralized signal processing.

For the detectors, the device advantageously comprises at least one data line to the control unit, and so a plurality of the detectors of the array, preferably all detectors of the array, are connected to the control unit in parallel. As a result, the detector data can be read in parallel, and a higher processing speed can be obtained for the calculation of movement data of the workpiece.

In particular, differently designed detectors can be used, and it is possible in this context to resort to conventional detectors available on the market.

Preferably, the control unit comprises at least one processor unit, preferably having one or more microprocessors, in particular having an FPGA (field programmable gate array). Furthermore, the control unit preferably comprises at least one program and data memory connected to the processor unit.

Advantageously, the movement data of the workpiece are measured by means of the motion sensors on a side of the workpiece lying opposite the processing side, on which the workpiece is processed by means of processing radiation. As a result, movement can be measured even when the workpiece is processed, and the arrangement of the motion sensors is not subject to spatial restrictions due to the beam path of processing radiation or optical components for processing radiation.

Preferably, the workpiece lies on the transport device for processing purposes, and processing by means of processing radiation is implemented from above. Thus, movement data of the workpiece are advantageously acquired from below. In particular, it is advantageous that at least some of the motion sensors, preferably the array of motion sensors, and particularly preferably all motion sensors are arranged on the side of the transport device opposite the deflection unit, in particular arranged under the transport device.

With regards to improving the measurement quality, additional illumination is advantageous, in particular infrared illumination, in particular directed at the workpiece from above. Thus, when correction data are acquired, the workpiece is advantageously illuminated by means of infrared radiation, in particular from the side of the workpiece opposite the sensor. The device therefore preferably comprises a radiation source for infrared radiation, which is preferably arranged and designed for an illumination of the workpiece from the side from which the processing is implemented.

It is advantageous that, in method step B.1, location data of the workpiece are acquired by means of at least one optical barrier, and, in method step B.2, movement data of the workpiece are acquired by means of optical tracking sensors. Optical barriers and tracking sensors are standard components which can be obtained cost-effectively on the open market while having a high measurement precision at the same time.

Greater precision within the scope of recognizing the pose is obtained by virtue of the location data of the workpiece being ascertained by means of a camera or an optical micrometer.

It is therefore advantageous that, in method step B.1, location data of the workpiece (2) are acquired by means of at least one pose sensor from the group of optical barrier, camera and optical micrometer.

In method step B of an advantageous configuration of the method according to the invention, at least one image of the surface of the workpiece, in particular a spatially resolved image thereof and/or a processed spatially resolved image thereof, in particular a spatially resolved image thereof processed by means of a Fourier transform, is captured where processing by means of processing radiation takes place. Using image analysis methods known per se, a structure created by means of processing radiation can be located in the spatially resolved image, and so pose data of the structure can be ascertained from the spatially resolved image. Thus, a pose of a structure created on the workpiece by means of processing radiation is preferably determined by means of the captured spatially resolved image.

In particular, it is advantageous to record a plurality of images during the processing such that a change in pose of the structure created by means of processing radiation can also be ascertained.

Advantageously, structure dimensions of the structure created by means of processing radiation, in particular at least one distance between spaced-apart structure portions of the structure created by means of processing radiation, are aligned. In an alternative to that or, preferably, in addition, it is advantageous that at least one distance between a plurality of the structures created by means of processing radiation is aligned with the structures captured in the spatially resolved image and/or a distance of the structure formed by means of processing radiation is aligned with one or more edges of the workpiece. This allows a deviation of the distances from the specified distances to be detected and, for further processing, allows a correction of the time of processing and/or of the deflection of processing radiation brought about by means of the optical deflection unit, in order to reduce, preferably avoid, the detected deviation.

Advantageously, the workpiece is illuminated, particularly preferably illuminated by means of infrared light, while correction data are captured. The device according to the invention therefore preferably comprises an illumination apparatus, particularly preferably an illumination apparatus designed to emit infrared radiation.

The scope of the invention includes the use of different types of processing radiation for the processing, in particular ion beams. The use of electromagnetic radiation, in particular laser radiation, is particularly preferred. It is therefore particularly advantageous that, in method step B, the workpiece is processed by means of laser radiation. Laser radiation has a high energy density and a low divergence and is therefore particularly suitable for the creation of structures on a workpiece.

A further source of error when processing a workpiece by means of processing radiation is present if workpieces are uneven or have different height profiles. The method according to the invention and the device according to the invention are particularly suitable for processing flat, in particular plate-like workpieces, in particular for processing semiconductor substrates in order to produce components, in particular in order to produce photovoltaic solar cells.

Thus, a workpiece is advantageously provided on the transport device within the scope of the method according to the invention, the workpiece being a dimensionally stable workpiece, in particular a planar, in particular plate-like workpiece, preferably a semiconductor substrate, particularly preferably a photovoltaic solar cell.

Thus, the device according to the invention is advantageously designed to form a structure on a workpiece, the workpiece being a dimensionally stable workpiece, in particular a planar, in particular plate-like workpiece, preferably a semiconductor substrate, particularly preferably a photovoltaic solar cell.

Such planar workpieces may have unevenness, and so, for a workpiece located on the transport device, there is a height difference between different locations on the workpiece, in particular between the edges and the central region of the workpiece.

Therefore, the height profile of the workpiece, preferably of the processing side of the workpiece, is captured in an advantageous development of the method according to the invention. The processing side of the workpiece is the side on which processing radiation is incident. Additionally, at least one of the following parameters
time of processing;
the deflection of processing radiation brought about by means of the deflection unit;
focusing processing radiation by means of a focusing apparatus
   is adapted, in particular corrected, dependent on the height profile. In particular, it is advantageous to adapt, in particular correct, the time of processing and/or the deflection of processing radiation brought about by means of the deflection unit.

Dependent on the angle at which the processing radiation is incident on the surface of the workpiece, a height difference, in particular on account of an uneven workpiece, may lead to a spatial deviation during the processing. There thus advantageously is an adaptation, in particular correction, of the time of processing and/or the deflection of processing radiation brought about by means of the deflection unit, in order to correct a spatial deviation on account of a height difference detected by means of the height profile.

Advantageously, a focusing apparatus is used during the processing in order to focus processing radiation on a processing point on the workpiece. As a result, higher energy densities can be obtained, and smaller structures can be formed. If the height profile of the workpiece is known, the focusing apparatus is preferably controlled in such a way that focusing of processing radiation is always implemented on the surface of the workpiece.

As a result, incorrect focusing of processing radiation on account of height differences of the workpiece, in particular a bend of a planar workpiece, is avoided.

The problem stated at the outset is also solved by a device for forming a structure on a workpiece by means of processing radiation.

The device according to the invention comprises a transport device for moving the workpiece along a trajectory, a radiation source for creating the processing radiation and a control device for controlling a time of processing and/or the deflection of processing radiation for processing the workpiece. Furthermore, the device comprises optical sensors for acquiring pose data of the workpiece.

It is essential that the optical sensors are designed as motion sensors for capturing a movement of the workpiece, and that the device additionally comprises at least one optical pose sensor for acquiring location data of the workpiece. In this context, the scope of the invention includes the use of a sensor designed as a motion sensor from a technical point of view as a pose sensor. Thus, a degree of coverage of a sensor field of a motion sensor can be measured in order to measure the pose of the workpiece relative to the motion sensor and the motion sensor, and so the detector designed as a motion sensor per se represents a pose sensor.

Hence, the device according to the invention enables capture of the pose of the workpiece by means of the pose sensor and capture of the movements by means of the motion sensors, and so, using the captured pose as a starting point, a workpiece trajectory can be determined by means of the data from the motion sensors, the said workpiece trajectory corresponding to the actual trajectory, i.e. also considering deviations on account of changes in speed during the transport by the transport device or a movement of the workpiece on the transport device.

The method according to the invention has the advantage that an accurate alignment of processing radiation on the desired location of processing on the surface of the workpiece is achieved. This enables the use of optical elements such as cylindrical lenses, for example, as described hereinbelow.

Therefore, the acquisition region of the pose sensor is advantageously arranged in front of the acquisition region of at least a subset of the motion sensors, preferably in front of the acquisition region of all motion sensors, in a transport direction of the transport device. As a result, during workpiece transport, the calculation of the workpiece trajectory by means of the data from the motion sensors is made possible from the moment the location is captured by the pose sensor.

Advantageously, at least a subset of the motion sensors, preferably all motion sensors, are designed as tracking sensors. In an alternative to that or preferably in addition, the pose sensor is designed as an optical barrier. As described above, use can be made here of commercially available tracking sensors and optical barriers, which allow cost-effective, high-precision measurements. As described above, greater precision is obtained in an advantageous configuration, in which the pose sensor is designed as a camera or optical micrometer.

Optical tracking sensors are known in particular for use in computer mice for recognizing movement. Such tracking sensors are advantageously used as optical tracking sensors.

It is therefore advantageous to design the optical tracking sensors as described in U.S. Pat. No. 7,057,148 B2.

The optical deflection unit preferably comprises one or more movable mirrors, in particular galvanometric mirrors. In a further advantageous configuration, the deflection unit comprises at least one polygon mirror wheel. In particular, it is advantageous to design the deflection unit with a combination of at least one galvanometric mirror and a polygon mirror wheel.

As described above, it is advantageous to take a height profile of the workpiece into account. The device according to the invention therefore advantageously comprises a height profile measuring unit for determining a height profile of a workpiece arranged on the transport device.

The height profile measuring unit is preferably designed as a triangulation sensor, wherein the height profile is preferably determined by means of a triangulation measurement using laser line or structured-light projection.

Knowledge of height data allows implementation of a correction of the aforementioned time of processing and/or of the deflection of movement radiation by means of the optical deflection unit in order to correct the location of processing on the workpiece.

Advantageously, the device according to the invention comprises a focusing apparatus for processing radiation. As described above, the energy density can be increased, and structures with smaller dimensions can be created, as a result. Advantageously, the control unit is designed to interact with the height profile measuring unit and the focusing apparatus in order to control the focusing apparatus dependent on the height profile data from the height profile measuring unit.

This ensures that the focus of the movement radiation is corrected even in the event of height differences of the workpiece, in particular in the event of unevenness of the workpiece, and in particular that the said focus is always located on the surface of the workpiece or follows the surface.

Advantageously, the focusing apparatus comprises a passive component, in particular an optical lens with a fixed focal length, and an active component, in particular a liquid lens or a mirror system, wherein the active component, e.g. a liquid lens or a mirror system, shifts the focus on the basis of the height data from the height profile measuring unit. Advantageously, the focusing apparatus is designed and controlled as described in Jahn, Axel, 3-dimensional beam shaping for dynamic adjustment of focus position and intensity distribution for laser welding and cutting, http://publica.fraunhofer.de/documents/N-645639.html.

Preferably, the device according to the invention is designed to carry out the method according to the invention, especially an advantageous embodiment thereof.

Therefore, the optical sensors are advantageously designed such that correction data of the workpiece are acquired by means of at least one optical sensor of the device while the workpiece is being processed by means of processing radiation, wherein the correction data include movement data of the workpiece and/or position data of a structure created on the workpiece by means of processing radiation, and the control device is designed to interact with the optical sensors such that, dependent on the correction data, the deflection of processing radiation by means of the deflection unit is adapted, in particular corrected, by means of the control device.

In this way, the advantages explained above are obtained.

The scope of the invention includes the transport device being designed to transport the workpiece along a non-rectilinear trajectory. In particular, transport of the workpiece on a curved, in particular circular trajectory is included within the scope of the invention. Likewise, forming a structure on a workpiece in the roll-to-roll process (R2R process), in particular on a strip-shaped workpiece, is included within the scope of the invention. For integration in an in-line process, it is advantageous that the transport device for transporting the workpiece is formed on a rectilinear trajectory.

As described above, the method according to the invention and the device according to the invention enable very spatially accurate impingement of the workpiece with processing radiation at the desired location on the surface of the workpiece. In a particularly advantageous manner, this can be combined with optics, in particular microlens arrays or cylindrical lenses, which create relatively small structures on account of a large numerical aperture but have only small image fields. As a result of the workpiece transport, it is possible to create the small structures with stable positions even over a large area. In principle, it is known that cylindrical lenses can be used advantageously to form structures on a workpiece by means of processing radiation, for example as described in Khan et al. Formation of thin laser ablated contacts using cylindrical lens, https://doi.org/10.1063/5.0056740.

Therefore, an optical element for focusing processing radiation, in particular an optical lens, preferably a cylindrical lens, is advantageously arranged in the beam path of processing radiation between the deflection unit and the workpiece. The optical element, preferably the cylindrical lens, is preferably arranged in the vicinity of the workpiece, in particular at a distance of less than 20 cm, more preferably less than 10 cm, in particular less than 5 cm from the workpiece. Particularly narrow structures can be formed as a result.

### BRIEF DESCRIPTION OF THE DRAWINGS

Further advantageous features and preferred embodiments will be explained below on the basis of exemplary embodiments and with reference to the figures. In the figures:

FIG. 1 shows a first exemplary embodiment of a device according to the invention for forming a structure on a workpiece by means of processing radiation;

FIG. 2 shows a plan view of a sensor unit of the device depicted in FIG. 1;

FIG. 3 shows a plan view of a processed workpiece, and

FIG. 4 shows a second exemplary embodiment of a device according to the invention.

### DETAILED DESCRIPTION

All of the figures show schematic illustrations which are not true to scale. Identical reference signs in the figures designate identical or identically acting elements.

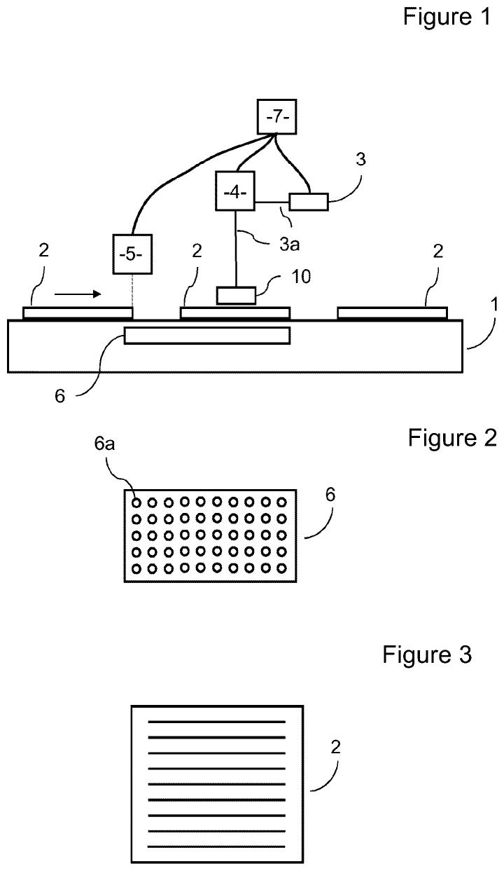

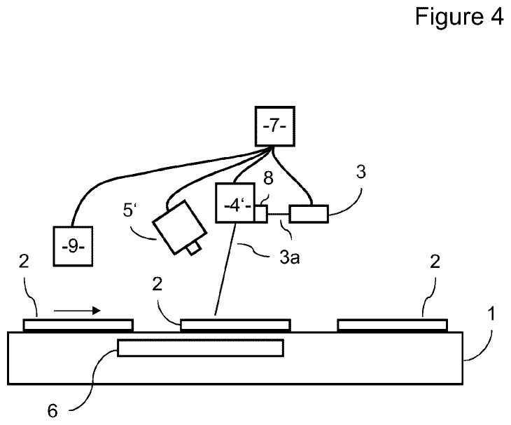

The exemplary embodiments of a device according to the invention for forming a structure on a workpiece by means of processing radiation, as are depicted in side views in FIGS. 1 and 4, are designed to process semiconductor substrates by means of laser radiation. The semiconductor substrates represent precursors for producing photovoltaic solar cells. The precursors comprise a substrate in the form of a silicon wafer, on which a dielectric layer, a silicon dioxide layer in the present case, is formed on a processing side located at the top in the figures. A plurality of parallel, rectilinear structures are formed through laser ablation using processing radiation in the form of laser radiation. The structures thus represent linear openings in the dielectric layer.

The first exemplary embodiment of a device according to the invention for forming a structure on a workpiece by means of processing radiation, as shown in FIG. 1, comprises a transport device 1 for moving workpieces 2, which in the present case are in the form of a precursor for photovoltaic solar cell production, as described above. The transport device 1 comprises a conveyor belt, on which the workpieces 2 are placed and moved from left to right along a rectilinear trajectory in a manner corresponding to the direction of the arrow shown in FIGS. 1 and 4.

FIGS. 1 and 4 each show a side view of the devices, and so accordingly only a respective edge of the workpieces 2 having the planar form is shown.

The device according to FIG. 1 also comprises a radiation source 3 which is embodied as a laser and serves to create processing radiation in the form of laser radiation. In the present case, the laser is designed as a solid-state laser, having a wavelength of 1064 nm and a pulse duration of 4 ns.

The device also comprises a deflection unit 4 which comprises a motor-rotatable mirror in the present case, in order to deflect a laser beam 3a from the radiation source 3 in a manner perpendicular to the transport direction and perpendicular to the processing side of the workpieces 2, located on the top, and hence in a manner perpendicular to the plane of the drawing of FIG. 1.

The device also comprises optical sensors:

In the transport direction, a pose sensor 5 is arranged in front of the region of the device where the workpieces 2 are processed by means of the laser beam 3a.

The pose sensor 5 comprises a plurality of optical barriers which are arranged in a rectilinear line perpendicular to the transport direction and hence perpendicular to the plane of the drawing in FIG. 1.

To this end, mirrors are attached in a region of the transport device 1 below the workpieces 2 that are transported by the transport device. The transport means of the transport device 1, presently the conveyor belt, is configured such that no elements of the conveyor belt are arranged in the region of the mirrors, with the result that the optical path between the housing 5 of the pose sensor 5 arranged at the top in FIG. 1 and the mirrors arranged in the transport direction 1 is only covered by the workpieces 2.

Thus, the time at which a leading edge of the workpiece 2 in the transport direction covers the optical beam path of the optical barrier is detected by means of the pose sensor 5. Moreover, by way of a coverage time offset between the individual optical barriers arranged in a straight line perpendicular to the transport direction, it is also possible to detect an oblique position of the workpiece should the leading edge of the workpiece not be perpendicular to the transport direction. Hence, the absolute pose of the workpiece 2 is detected relative to the device by means of the pose sensor.

The optical sensors also comprise a motion sensor array 6. The motion sensor array 6 comprises a plurality of optical tracking sensors 6a, which are arranged on the intersection points of a grid which is a square grid in this case. FIG. 2 shows a plan view of the motion sensor array 6 from above, with the optical tracking sensors being depicted as a circle in each case. The optical tracking sensor 6a at the top left corner has been provided with a reference sign by way of example.

In the present case, the optical tracking sensors are designed as described in the patent U.S. Pat. No. 7,057,148 B2. In the present case, a single tracking sensor consists of an optical detector, with 30×30 pixels in the present case, an integrated illumination and a microcontroller which contains a digital signal processor unit for calculating the movement data.

Hence, the movement of the workpiece 2 is detected by means of the optical tracking sensors of the motion sensor array 6, from the moment at which the pose of the workpiece is detected by means of the pose sensor 5 and at least until the time at which the workpiece is processed by means of the laser beam 3a. A movement of the workpiece over time and likewise also a rotation of the workpiece can be detected on account of the multiplicity of optical tracking sensors 6a and on the basis of differences in the movement velocity and, in particular, components of the movement velocity perpendicular to the transport direction.

The acquisition region of the optical tracking sensors 6a is consequently arranged behind the acquisition region of the pose sensor in the transport direction.

FIG. 3 depicts a plan view from above of a workpiece 2 that has already been fully processed. The black parallel lines label the cutouts created by laser ablation by means of the laser beam 3a. The rectilinear cutouts are created parallel to the transport direction during the processing. However, in the device depicted in FIG. 1, the laser beam can only be moved perpendicular to the transport direction by means of the deflection unit 4, as described above. However, movement of the laser beam and ablation of the dielectric layer to form the cutouts is implemented at a significantly higher speed than the movement speed of the workpiece 2 on the transport device 1. Thus, adjacent portions of the structures can always be created in sequential order. On account of an extent of the ablations created by means of the laser parallel to the movement direction as well, respective cutouts that overlap in the transport direction are thus successively created in each structure, and so a continuous rectilinear cutout is formed for each structure.

The device according to the exemplary embodiments depicted in FIGS. 1 and 4 comprises a control device 7 in each case. The latter is connected to the optical sensors in order to acquire the measurement data from the optical sensors and connected to the radiation source 3 in order to switch beam creation on and off, and also connected to the deflection unit in order to control the deflection of the laser beam 3a by means of the deflection unit.

The connection to the motion sensor array 6 has not been depicted pictorially in order to provide a better overview.

The device according to FIG. 1 is designed to carry out an exemplary embodiment of a method according to the invention:

A workpiece 2 is provided on the transport device 1 in a method step A. In method step B, the workpiece 2 is moved by the transport device 1 along the rectilinear trajectory labeled by an arrow, and the workpiece 2 is processed by means of processing radiation in the form of a laser beam 3a while the workpiece 2 is moved by means of the transport device 1. The control device 7 is used to control the time of processing and the optical deflection unit 4, which is controlled by the control device 7, is used to control the location where the workpiece is processed by means of processing radiation, in order to form the rectilinear, parallel structures shown in FIG. 3.

It is essential that, in method step B, while the workpiece is processed by means of processing radiation, correction data of the workpiece are acquired by means of the sensors 5 and 6.

In the present case, the correction data comprise the position data acquired by means of the pose sensor 5 and the movement data of the workpiece 2 acquired by means of the optical tracking sensors 6a of the motion sensor 6.

Dependent on the correction data, the time of processing and/or the deflection of processing radiation brought about by means of the deflection unit 7 is corrected by means of the control device.

For example, should the plurality of optical barriers of the pose sensor 5 detect that the leading edge of the workpiece 2 is not perpendicular but at an angle to the transport direction, the time for creating the structures is modified accordingly since, in the case of a workpiece 2 entering the processing region at an angle, only one structure is formed first, followed by an increasing number of structures in order to ensure a uniform distance of the start of the structures from the edge of the workpiece.

Moreover, the deflection of the laser beam 3a by means of the deflection unit 7 is corrected since the structures must be formed as structures running at an angle in the reference system of the processing device in accordance with the angle, as detected by means of the pose sensor 5, included between the leading edge of the workpiece 2 and the transport direction in order to form structures on the workpiece 2 that run parallel to the side edges or perpendicular to the leading edge of the workpiece 2.

FIG. 4 shows a second exemplary embodiment of a device according to the invention. Essential elements and functionalities correspond to those of the first exemplary embodiment. Thus, in order to avoid repetition, only the essential differences are discussed below:

In the device shown in FIG. 4, the pose sensor 5′ is in the form of a spatially resolving camera, with a CMOS chip in the present case.

The deflection unit 4′ of the device according to FIG. 4 comprises two galvanometric mirrors which allow a deflection in all the desired spatial directions along the processing plane, with the result that the laser beam 3a can be deflected not only with components perpendicular to the transport direction but likewise with components parallel to the transport direction of the transport device 1.

In a modification of the exemplary embodiment, use is made of a combination of a polygon mirror wheel and a galvanometer as a deflection unit 4′, in order to be able to move the beam particularly quickly parallel to the workpiece and perpendicular to the movement direction. The correction of the movement along the transport direction then resides with the galvanometer while the beam is moved uniformly perpendicular to the transport direction. An advantage of this embodiment lies in the option of being able to realize a particularly large processing field for a large numerical aperture with a very high processing speed.

Additionally, a focusing apparatus 8 for focusing the laser beam 3a on the processing side of the workpiece 2 located at the top in FIG. 4 is arranged on the deflection unit 4.

Furthermore, the device according to FIG. 4 comprises a height profile measuring unit 9 for measuring a height profile of the processing side of the workpiece 2.

Pose sensor 5′, focusing apparatus 8 and height profile measuring unit 9 are also connected to the control unit 7.

In the device depicted in FIG. 4, an image of the processing region can thus be recorded in a continuous sequence by means of the pose sensor 5′ in the form of a camera. A leading edge of the workpiece 2 is detected by image analysis. These data thus allow detection of the pose of the workpiece 2 upon entry into the processing region of the device and, in particular, also a detection of an oblique position of the entering leading edge of the workpiece 2 should the latter not be perpendicular to the transport direction of the transport device 1. This enables a correction as already described in relation to exemplary embodiment 1.

Moreover, the device shown in FIG. 4 allows the pose of the structures created by means of processing radiation to be detected by means of the pose sensor 5′. In the present exemplary embodiment, the distance between the structures and the distance from the edges of the workpiece 2 are specified. The distance between the structures and the distance from the edges can be determined by means of image analysis during the structure creation. Should these not correspond to the specified distance values, the deflection of the laser beam by means of the deflection unit 4′ is corrected in order to form the correct distances, at least during subsequent processing.

The device according to FIG. 4 additionally comprises a height profile measuring unit 9. In the present case, the latter is designed to capture a two-dimensional height profile of the workpiece 2. To this end, the height profile measuring unit is designed as a laser triangulation measuring head in the present case.

The height profile of a workpiece 2 as determined by means of the height profile measuring unit 9 is transmitted to the control device 7 which controls the focusing apparatus 8 accordingly such that the focus is always located at the height at the current location of processing as specified by the height profile and hence always located on the surface of the processing side of the workpiece 2.

The device according to FIG. 4 additionally comprises the motion sensor array 6 for acquiring movement data, which was already described in relation to FIG. 1. Thus, redundant information is available with regards to the location and the movement of the workpiece 2. Hence, the accuracy when acquiring the characteristic data of the workpiece can be increased by way of correction functions, for example by forming an arithmetic mean.

In a modification of an exemplary embodiment of a method according to the method, characteristic data are only acquired by means of the pose sensor 5′, which acquires position data of the structure created on the workpiece by means of processing radiation, in the present case the position data of the rectilinear cutouts on the workpiece 2 created by means of the laser beam 3a.

In the exemplary embodiment shown in FIG. 4, the laser beam 3a is deflected on a cylindrical lens 10 by the deflection unit 4. The cylindrical lens 10 is aligned with its cylinder axis transverse to the transport direction. The use of a cylindrical lens allows the formation of particularly narrow structures, in particular narrow lines parallel to the cylinder axis of the cylindrical lens. The cylindrical lens 10 has a particularly short focal length, approximately 150 mm in the present case, and can thus be particularly advantageously combined with the transport system since, as a result of the movement of the workpiece, only a small movement of the beam in the transport direction needs to be ensured. Since the area to be processed is not restricted along the transport direction, very small structures can be realized on a large area. The distance between cylindrical lens 10 and workpiece 2 is in the range of between 1 cm and 5 cm.

### LIST OF REFERENCE SIGNS

1 Transport device

2 Workpiece

3 Radiation source

3a Laser beam

4, 4′ Deflection unit

5, 5′ Pose sensor

6 Motion sensor array

6a Optical tracking sensors

7 Control device

8 Focusing apparatus

9 Height profile measuring unit

10 Cylindrical lens

1. A method for forming a structure on a workpiece (2) by processing radiation,
the method comprising:
a. providing the workpiece (2) on a transport device (1);
b. moving the workpiece (2) along a trajectory by the transport device (1) and processing the workpiece (2) using processing radiation while the workpiece (2) is moved by the transport device (1), with, in order to form the structure, a time of processing being controlled by a control device (7) and, a location of the processing of the workpiece (2) by the processing radiation being controlled by a control device (7)-controlled optical deflection unit (4, 4′) for processing radiation, and
in method step B, while the workpiece (2) is processed by the processing radiation, acquiring correction data of the workpiece (2) by at least one optical sensor, the correction data comprising at least one of movement data of the workpiece (2) or position data of a structure created on the workpiece (2) the processing radiation, and, dependent on the correction data, deflection of processing radiation brought about by the deflection unit (4, 4′) is determined by the control device (7).

2. The method as claimed in claim 1, further comprising in method step B, detecting a pose of the workpiece (2) in a method step B.1 before the workpiece (2) is processed by the processing radiation, and, after method step B.1, acquiring the movement data of the workpiece (2) in a method step B.2.

3. The method as claimed in claim 2, further comprising
starting the acquisition of the movement data in accordance with method step B.2 no later than the implementation of method step B.1 and continuing the acquisition of the movement data at least until the structure is being created by the processing radiation.

4. The method as claimed in claim 2, further comprising,
in method step B.2, acquiring the movement data of the workpiece (2) by a plurality of optical detectors.

5. The method as claimed in claim 4, further comprising, in method steps B.1 and B.2, acquiring characteristic data by different optical detectors.

6. The method as claimed in claim 5, further comprising,
in method step B.1, acquiring location data of the workpiece (2) by at least one pose sensor selected from the group consisting of optical barrier, camera and optical micrometer, and, in method step B.2, acquiring the movement data of the workpiece (2) by optical tracking sensors (6a).

7. The method as claimed in claim 1, further comprising,
in method step B, capturing at least one spatially resolved image of a surface of the workpiece (2), where the processing by the processing radiation takes place, and determining a pose of a structure created on the workpiece (2) by the processing radiation based on the image.

8. The method as claimed in claim 7, further comprising at least one of a) aligning structure dimensions of the structure created by the processing radiation, with the structures captured in the spatially resolved image, or b) aligning a distance of the structure formed by the processing radiation with one or more edges of the workpiece.

9. The method as claimed in claim 1, wherein, in method step B, the processing radiation is laser radiation.

10. The method as claimed in claim 1 further comprising acquiring
a height profile of the workpiece (2), and carrying out at least one of the following corrections
time of processing;
the deflection of processing radiation brought about by means of the deflection unit (4, 4′); or
focusing processing radiation by means of a focusing apparatus dependent on the height profile.

11. A device for forming a structure on a workpiece (2) using processing radiation, the device comprising:
a transport device (1) for moving the workpiece (2) along a trajectory,
a radiation source for creating processing radiation,
a control device (7) for controlling at least one of a time of processing or a deflection of processing radiation for processing the workpiece (2), and
optical sensors for acquiring pose data of the workpiece (2), wherein the optical sensors comprise motion sensors for capturing a movement of the workpiece (2), and
at least one optical pose sensor (5, 5′) for acquiring location data of the workpiece (2).

12. The device as claimed in claim 11, wherein
an acquisition region of the pose sensor is arranged in front of an acquisition region of at least a subset of the motion sensors in a transport direction of the transport device (1).

13. The device as claimed in claim 11, wherein at least a subset of the motion sensors comprise tracking sensors.

14. The device as claimed in claim 11, further comprising
a height profile measuring unit (9) for determining a height profile of a workpiece (2) arranged on the transport device (1).

15. The device as claimed in claim 11, wherein,
while the workpiece (2) is processed by the processing radiation, the optical sensors are configured to acquire correction data of the workpiece (2) by at least one of the optical sensors, with the correction data comprising at least one of movement data of the workpiece (2) or position data of a structure created on the workpiece (2) by the processing radiation, and
the control device (7) is configured to interact with the optical sensors such that, dependent on the correction data, at least one of a time of processing or a deflection of processing radiation brought about by the deflection unit (4, 4′) is corrected by the control device (7).

16. The device as claimed in claim 11, wherein the pose sensor comprises at least one of an optical barrier, camera or optical micrometer.

17. The device as claimed in claim 14, further comprising a focusing apparatus (8) for processing radiation, and the control unit is configured to interact with the height profile measuring unit (9) and the focusing apparatus (8) in order to control the focusing apparatus (8) dependent on height profile data from the height profile measuring unit (9).

18. The method as claimed in claim 8, wherein the aligning of the structure dimensions of the structure created by the processing radiation, includes aligning at least one distance between spaced-apart structure portions of the structure created by the processing radiation, or at least one distance between a plurality of the structures created by the processing radiation.

19. The method as claimed in claim 3, wherein the acquisition of the movement data continues until the creation of the structure by the processing radiation is completed.
